(19) United States
(12) Patent Application Publication
(10) Pub. No.: US 2026/0162868 A1
(43) Pub. Date: Jun. 11, 2026

(54) MAGNETIC COUPLING COIL COMPONENT AND METHOD OF MANUFACTURING THE SAME

(71) Applicant: TAIYO YUDEN CO., LTD., Tokyo (JP)

(72) Inventor: Tsubasa AZAMI, Tokyo (JP)

(21) Appl. No.: 19/413,084

(22) Filed: Dec. 9, 2025

(30) Foreign Application Priority Data
Dec. 10, 2024 (JP) 2024-215020

(51) Int. Cl. H01F 27/06; H01F 5/04; H01F 27/02; H01F 27/28; H01F 37/00

(52) U.S. Cl. CPC H01F 27/06; H01F 5/04; H01F 27/02; H01F 27/2847; H01F 37/005

(57) ABSTRACT

Provided is a magnetic coupling coil component having a high dimensional accuracy for the distance between two coil conductors. A magnetic coupling coil component according to one aspect includes: first and second coil conductors; a first base body portion covering the first coil conductor; and a second base body portion covering the second coil conductor. The first coil conductor has a first winding portion extending around a coil axis. The second coil conductor has a second winding portion extending around the coil axis. The first base body portion has a main body portion and at least one protruding portion. The end surface of the main body portion in a first direction along the coil axis is a first surface. At least one protruding portion protrudes from the first surface. The second coil conductor is positioned such that the second winding portion contacts with at least one protruding portion.

### CROSS-REFERENCE TO RELATED APPLICATIONS

This application is based on and claims the benefit of priority from Japanese Patent Application Serial No. 2024-215020 (filed on Dec. 10, 2024), the contents of which are hereby incorporated by reference in their entirety.

### TECHNICAL FIELD

The present disclosure relates mainly to a magnetic coupling coil component and a method of manufacturing the magnetic coupling coil component.

### BACKGROUND

A magnetic coupling coil component includes two or more coil elements magnetically coupled to each other. The magnetic coupling coil components are used as a common mode choke coil, a transformer, or a coupled inductor.

In the magnetic coupling coil component disclosed in Japanese Patent Application Publication No. 2016-131208 (“the '208 Publication”), two coil conductors are arranged along the coil axis.

In a magnetic coupling coil component including two coil conductors arranged along the coil axis, the distance between the two coil conductors in the coil axis direction has a significant effect on the coupling coefficient. Therefore, in order to achieve a desired coupling coefficient in such a magnetic coupling coil component, high dimensional accuracy is required for the distance between the coil conductors.

In the magnetic coupling coil component of the '208 Publication, each of the two coil components is configured as a laminate, and these laminates are joined to each other with a non-magnetic adhesive (joint 13). Thus, the distance between the coil conductors varies in accordance with the thickness of the adhesive. It is difficult to precisely control the thickness of the adhesive for joining two laminates, because the thickness of the adhesive between the two laminates tends to vary due to variations in thickness during application and the force for pressing one laminate against the other after the adhesive is applied. In addition, non-magnetic adhesives may lower the inductance value.

In the magnetic coupling coil component of the '208 Publication, the distance between the two coil conductors is defined by the number of insulator layers (e.g., the insulating layers 11d1 to 11d3 shown in FIG. 3) placed at the end of each laminate in the stacking direction and the thickness of each insulator layer. Since it is difficult to uniform the thickness of the sheet-like insulator layers, it is difficult to achieve high dimensional accuracy for the distance between the coil conductors in the magnetic coupling coil component of the '208 Publication, where the distance between the coil conductors is defined by the total thickness of multiple insulator layers.

### SUMMARY

It is an object of the present disclosure to solve or alleviate at least part of the drawbacks mentioned above. One particular object of the present disclosure is to provide a magnetic coupling coil component having a high dimensional accuracy for the distance between two coil conductors. The various inventions disclosed herein may be collectively referred to as “the invention”.

Other objects of the disclosure will be made apparent through the entire description in the specification. The inventions recited in the claims may also address any other drawbacks in addition to the above drawback.

A magnetic coupling coil component according to one aspect of the disclosure includes: a first coil conductor; a second coil conductor; a first base body portion covering the first coil conductor; a second base body portion covering the second coil conductor; a first external electrode connected to one end of the first coil conductor; a second external electrode connected to another end of the first coil conductor; a third external electrode connected to one end of the second coil conductor; and a fourth external electrode connected to another end of the second coil conductor. The first coil conductor has a first winding portion extending in a circumferential direction around a coil axis. The second coil conductor has a second winding portion extending in a circumferential direction around the coil axis. The first base body portion has a main body portion and at least one protruding portion. The end surface of the main body portion in a first direction along the coil axis is referred to as a first surface. At least one protruding portion protrudes from the first surface of the main body portion. The second coil conductor is positioned such that the second winding portion is in contact with at least one protruding portion.

### ADVANTAGEOUS EFFECTS

One aspect of the present disclosure provides a high dimensional accuracy for the distance between two coil conductors in a magnetic coupling coil component.

### BRIEF DESCRIPTION OF THE DRAWINGS

FIG. 1 is a schematic view of a magnetic coupling coil component according to one embodiment of the present disclosure.

FIG. 2 is a perspective view schematically showing the magnetic coupling coil component according to one embodiment of the present disclosure.

FIG. 3 is a transparent view of the magnetic coupling coil component of FIG. 2, viewed from the front.

FIG. 4 is schematic view of a first base body portion and a second coil conductor included in the magnetic coupling coil component of FIG. 2.

FIG. 5 is a flow chart showing a process of manufacturing the magnetic coupling coil component according to one embodiment of the present disclosure.

FIG. 6A is a schematic view for explaining a step of placing a first coil conductor in a molding die, in the process of manufacturing the coil component.

FIG. 6B is a schematic view for explaining a step of forming the first base body portion, in the process of manufacturing the coil component.

FIG. 7 is a schematic view showing the step of assembling the second coil conductor to the first base body portion.

FIG. 8 is a schematic view showing the step of assembling the second coil conductor to the first base body portion.

FIG. 9 is a schematic view showing a modification of the first base body portion.

### DESCRIPTION OF THE PREFERRED EMBODIMENTS

Various embodiments of the disclosure will be described hereinafter with reference to the appended drawings. Throughout the drawings, the same components common in the drawings are denoted by the same reference numerals. For convenience of explanation, the drawings are not necessarily drawn to scale. The following embodiments of the disclosure do not limit the scope of the claims. The elements included in the following embodiments are not necessarily essential to solve the problem addressed by the invention.

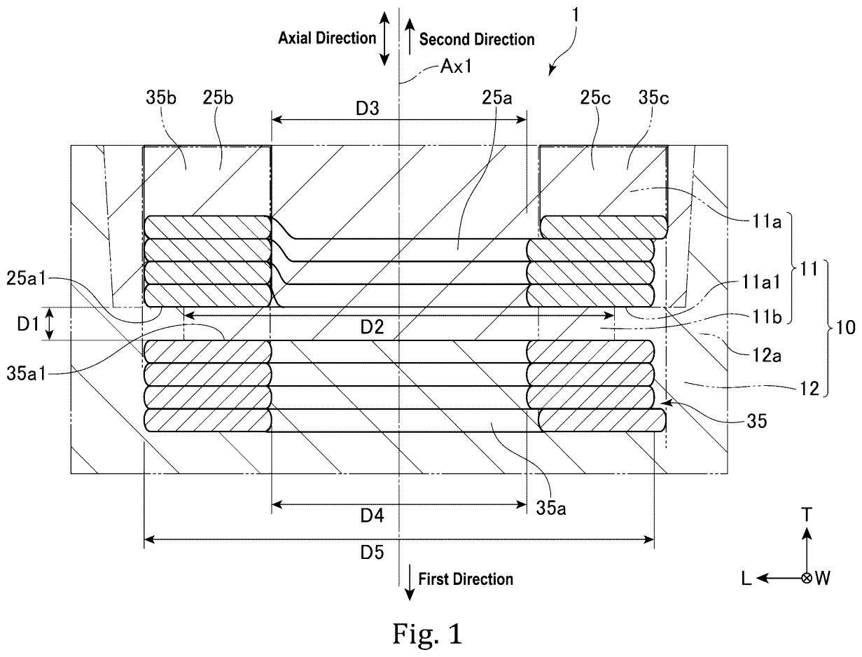

First, with reference to FIG. 1, an outline is given of a magnetic coupling coil component 1 according to one embodiment of the disclosure. As schematically shown in FIG. 1, the magnetic coupling coil component 1 according to one embodiment of the disclosure includes a base body 10, a first coil conductor 25 disposed in a first base body portion 11 of the base body 10, and a second coil conductor 35 disposed in a second base body portion 12 of the base body 10. The magnetic coupling coil component 1 may be used as a choke coil, a transformer, a coupled inductor, and any one of various other magnetic coupling coil components. When the magnetic coupling coil component 1 is in use, the first coil conductor 25 is magnetically coupled to the second coil conductor 35. FIG. 1 does not show external electrodes for simple illustration.

The first coil conductor 25 has a first winding portion 25a extending in the circumferential direction around the coil axis Ax1. The second coil conductor 35 has a second winding portion 35a extending in the circumferential direction around the coil axis Ax1. The first coil conductor 25 and the second coil conductor 35 are arranged along the coil axis Ax1. In the following description, the term “axial direction” refers to the direction along the coil axis Ax1. The term “first direction” refers to the direction from the first coil conductor 25 toward the second coil conductor 35 along the coil axis Ax1 in FIG. 1, and the term “second direction” refers to the direction opposite to the first direction.

The base body 10 is partitioned into the first base body portion 11 and the second base body portion 12. The first base body portion 11 includes a main body portion 11a, which covers the first coil conductor 25, and a protruding portion 11b, which protrudes in the first direction from the first surface 11a1 of the main body portion 11a. The first surface 11a1 is an end surface of the main body portion 11a in the first direction. The main body portion 11a also occupies the region radially inside the first winding portion 25a of the first coil conductor 25. The protruding portion 11b is connected to the portion of the main body portion 11a radially inside the first winding portion 25a. The first base body portion 11 can be produced with high dimensional accuracy by using a mold, for example.

The first winding portion 25a has a first coil surface 25a1. The first coil surface 25a1 is an end surface of the first winding portion 25a in the first direction. In one embodiment, the first coil surface 25a1 of the first winding portion 25a is exposed through the first surface 11a1 of the main body portion 11a. In other words, the main body portion 11a covers the first coil conductor 25 such that the first coil surface 25a1 of the first winding portion 25a is exposed through the first surface 11a1. The first coil surface 25a1 may be flush with the first surface 11a1.

The second coil conductor 35 is positioned in the second base body portion 12 such that the second winding portion 35a contacts the protruding portion 11b. In the illustrated embodiment, the second coil surface 35a1 of the second winding portion 35a is in direct contact with the protruding portion 11b. The second coil surface 35a1 is an end surface of the second winding portion 35a in the second direction.

In the magnetic coupling coil component 1, the distance between the first coil conductor 25 and the second coil conductor 35 in the axial direction can be equal to the dimension D1 of the protruding portion 11b in the axial direction. As mentioned above, the first base body portion 11 is produced with high dimensional accuracy, and therefore, the protruding portion 11b, which is a part of the first base body portion 11, can also have high dimensional accuracy for the dimension D1 in the axial direction. Also, the second coil conductor 35 is positioned such that the second coil surface 35a1 of the second winding portion 35a is in contact with the protruding portion 11b, and therefore, no material or composition (e.g., adhesive) other than the protruding portion 11b is interposed between the first coil conductor 25 and the second coil conductor 35. As noted, in the magnetic coupling coil component 1, the distance between the first coil conductor 25 and the second coil conductor 35 is equal to the dimension D1 of the protruding portion 11b in the axial direction, thereby achieving high dimensional accuracy for the distance between the first coil conductor 25 and the second coil conductor 35.

In one embodiment, the protruding portion 11b is formed integrally with the main body portion 11a. In other words, the main body portion 11a and the protruding portion 11b have one-piece structure. If the main body portion 11a and the protruding portion 11b are joined together with an adhesive, dimensional errors can occur in the distance between the first coil conductor 25 and the second coil conductor 35, depending on variations in the thickness of the adhesive. By contrast, with the first base body portion 11 formed such that the main body portion 11a and the protruding portion 11b have one-piece structure, the dimensional errors caused by the joining means of the main body portion 11a and the protruding portion 11b can be eliminated, and thus even higher dimensional accuracy can be obtained for the distance between the first coil conductor 25 and the second coil conductor 35.

Next, a description is given of the dimension of the protruding portion 11b in the radial direction centered on the coil axis Ax1. The radial direction centered on the coil axis Ax1 intersects perpendicularly with the axial direction along the coil axis Ax1. The protruding portion 11b has an outer dimension D2 in the radial direction. In one embodiment, the outer dimension D2 of the protruding portion 11b is larger than the inner diameter D3 of the first winding portion 25a.

In one embodiment, the outer dimension D2 of the protruding portion 11b is larger than the inner diameter D4 of the second winding portion 35a. With the outer dimension D2 of the protruding portion 11b being larger than the inner diameter D4 of the second winding portion 35a, the second coil surface 35a1 of the second winding portion 35a can be securely seated on the end surface of the protruding portion 11b in the first direction.

In one embodiment, the outer dimension D2 of the protruding portion 11b is smaller than the outer dimension D5 of the second winding portion 35a. If the outer dimension D2 of the protruding portion 11b is excessively large, the surrounding portion 12a of the second base body portion 12, which surrounds the protruding portion 11b on the radially outer side, has a reduced width in the radial direction. With the outer dimension D2 of the protruding portion 11b being smaller than the outer dimension D5 of the second winding portion 35a, the width of the surrounding portion 12a in the radial direction can be increased accordingly, thus ensuring the strength of the surrounding portion 12a.

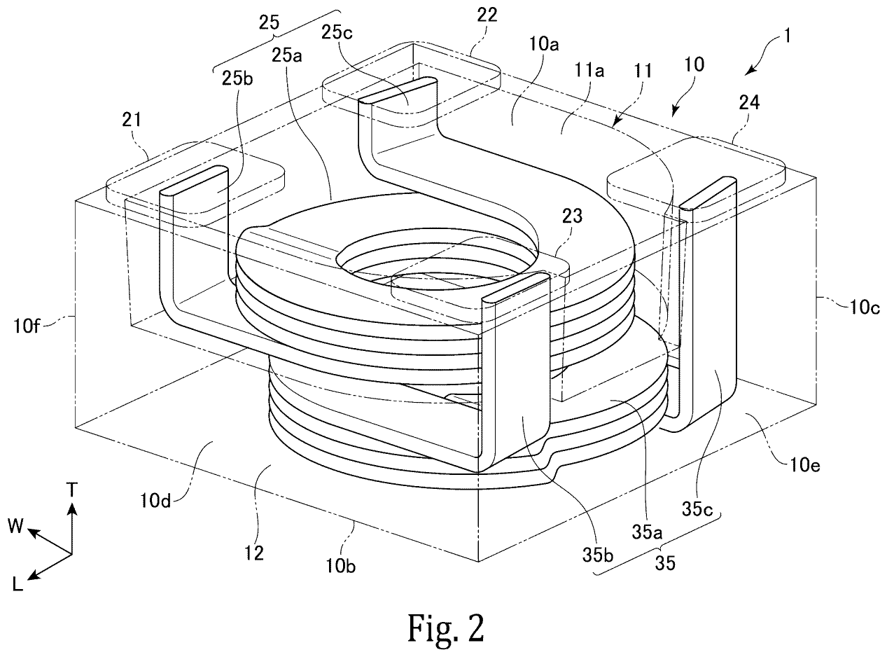

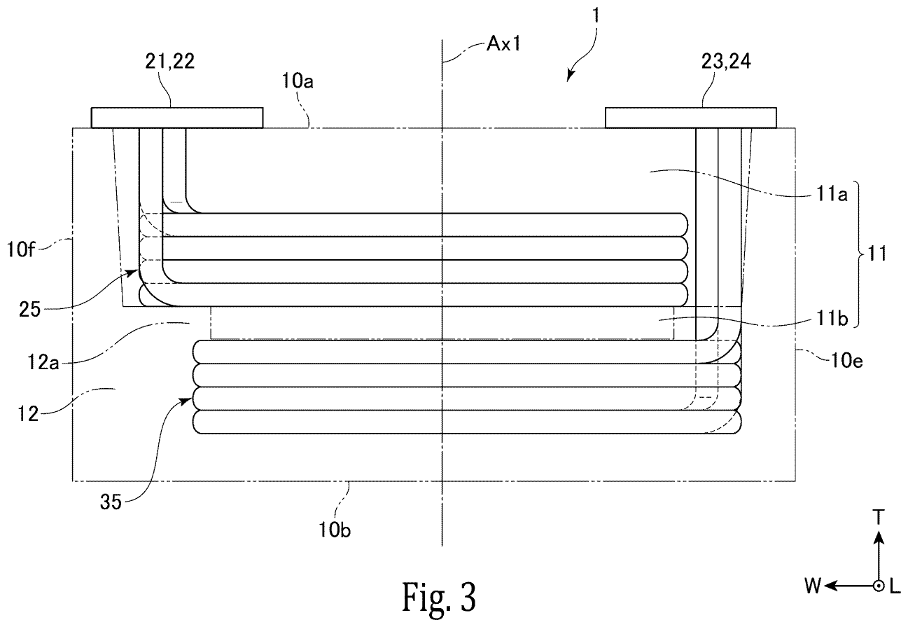

Next, with additional reference to FIGS. 2 and 3, a detailed description is given of the magnetic coupling coil component 1. FIG. 2 is a perspective view of the magnetic coupling coil component 1 according to one embodiment of the present disclosure, and FIG. 3 is a transparent view of the magnetic coupling coil component 1 viewed from the front.

As shown, the magnetic coupling coil component 1 includes, in addition to the base body 10, the first coil conductor 25, and the second coil conductor 35, a first external electrode 21 connected to one end of the first coil conductor 25, a second external electrode 22 connected to the other end of the first coil conductor 25, a third external electrode 23 connected to one end of the second coil conductor 35, and a fourth external electrode 24 connected to the other end of the second coil conductor 35. The first external electrode 21, the second external electrode 22, the third external electrode 23, and the fourth external electrode 24 are spaced apart from one another on the surface of the base body 10. The first external electrode 21 and the third external electrode 23 are provided on the base body 10 so as to be spaced apart from each other in the W-axis direction. The magnetic coupling coil component 1 is mounted on a circuit board via the first external electrode 21, the second external electrode 22, the third external electrode 23, and the fourth external electrode 24. The circuit board having the magnetic coupling coil component 1 mounted thereon can be installed in various electronic devices. The electronic devices in which the circuit board can be installed include smartphones, tablets, game consoles, electrical components of automobiles, servers, and various other electronic devices.

In one aspect, the base body 10 is formed of an insulating material into a rectangular parallelepiped shape. For example, the magnetic coupling coil component 1 has a dimension in the L-axis direction (length) of 0.5 mm to 6.0 mm, a dimension in the W-axis direction (width) of 0.5 mm to 10 mm, and a dimension in the T-axis direction (height) of 0.3 mm to 6 mm. In one embodiment, the length of the magnetic coupling coil component 1 may be larger than the width thereof. The term “rectangular parallelepiped” or “rectangular parallelepiped shape” used herein is not intended to mean solely “rectangular parallelepiped” in a mathematically strict sense. As described later, the corners and/or edges of the base body 10 may be rounded. The dimensions and the shape of the base body 10 are not limited to those specified herein.

The base body 10 has a first principal surface 10a, a second principal surface 10b, a first end surface 10c, a second end surface 10d, a first side surface 10e, and a second side surface 10f. The first principal surface 10a and the second principal surface 10b are at the opposite ends in the height direction (T-axis direction) of the base body 10, the first end surface 10c and the second end surface 10d are at the opposite ends in the length direction (L-axis direction) of the base body 10, and the first side surface 10e and the second side surface 10f are at the opposite ends in the width direction (W-axis direction) of the base body 10. The first principal surface 10a and the second principal surface 10b are opposed to each other in the T-axis direction. As shown in FIG. 1, the first principal surface 10a is at the top of the base body 10, and therefore, the first principal surface 10a may be referred to as a “top surface.” Likewise, the second principal surface 10b may be referred to as a “lower surface” or “bottom surface.”

In the embodiment shown, the first external electrode 21, the second external electrode 22, the third external electrode 23, and the fourth external electrode 24 are provided on the top surface 10a of the base body 10. When the magnetic coupling coil component 1 is mounted on a circuit board, the top surface 10a faces the circuit board. Therefore, the top surface 10a of the base body 10 may be herein referred to as “the mounting surface.” In one embodiment, the first external electrode 21, the second external electrode 22, the third external electrode 23, and the fourth external electrode 24 are provided on the base body 10 so as to be in contact with the top surface 10a only. In another embodiment, at least one of the first external electrode 21, the second external electrode 22, the third external electrode 23, and the fourth external electrode 24 may extend onto a surface of the base body 10 other than the top surface 10a. For example, the first external electrode 21 may extend to contact the second side surface 10f as well as the top surface 10a.

The top surface 10a and the bottom surface 10b are separated from each other by a distance equal to the height of the base body 10, the first end surface 10c and the second end surface 10d are separated from each other by a distance equal to the length of the base body 10, and the first side surface 10e and the second side surface 10f are separated from each other by a distance equal to the width of the base body 10. In this specification, a “length” direction, a “width” direction, and a “thickness” (or “height”) direction of the magnetic coupling coil component 1 correspond to the L-axis direction, the W-axis direction, and the T-axis direction in FIG. 1, respectively, unless otherwise construed from the context.

The base body 10 is made of an insulating material having an excellent insulation property. The base body 10 may be made of a magnetic material. The magnetic material for use in the base body 10 may be a soft magnetic alloy material, a composite magnetic material including magnetic particles dispersed in a resin, a ferrite material, or any other known magnetic materials.

In the embodiment shown, the first coil conductor 25 and the second coil conductor 35 are arranged along the coil axis Ax1. The coil axis Ax1 is an imaginary axis extending along the T-axis direction. Since the protruding portion 11b, which is a part of the insulating base body 10, is interposed between the first coil conductor 25 and the second coil conductor 35, the first coil conductor 25 and the second coil conductor 35 are located in the base body 10 so as to be separated from each other in the axial direction along the coil axis Ax1 by a distance equal to the dimension D1 of the protruding portion 11b in the axial direction. The dimension D1 of the protruding portion 11b in the axial direction can be, for example, 1/100 to 1/10 of the height dimension of the base body 10. The dimension D1 of the protruding portion 11b in the axial direction can be, for example, 0.05 to 0.2 mm. The outer dimension D2 of the protruding portion 11b in the radial direction can be, for example, 1.8 mm to 3.5 mm.

The first coil conductor 25 includes a first winding portion 25a, a first lead-out portion 25b that connects between one end of the first winding portion 25a and the first external electrode 21, and a second lead-out portion 25c that connects between the other end of the first winding portion 25a and the second external electrode 22.

The first winding portion 25a extends in a circumferential direction around a coil axis Ax1 extending along the T axis. The first winding portion 25a is located in the base body 10 so as to be opposed to the top surface 10a of the base body 10. The first lead-out portion 25b extends from one end of the first winding portion 25a to the top surface 10a of the base body 10 along the T axis. One end of the first lead-out portion 25b is exposed to the outside of the base body 10 through the top surface 10a of the base body 10. The first lead-out portion 25b is connected with the first external electrode 21 at the exposed surface exposed through the top surface 10a. The second lead-out portion 25c extends from the other end of the first winding portion 25a to the top surface 10a of the base body 10 along the T axis. One end of the second lead-out portion 25c is exposed to the outside of the base body 10 through the top surface 10a of the base body 10. The second lead-out portion 25c is connected with the second external electrode 22 at the exposed surface exposed through the top surface 10a.

The second coil conductor 35 includes a second winding portion 35a, a third lead-out portion 35b that connects between one end of the second winding portion 35a and the third external electrode 23, and a fourth lead-out portion 35c that connects between the other end of the second winding portion 35a and the fourth external electrode 24.

The second winding portion 35a extends in a circumferential direction around the coil axis Ax1. The second winding portion 35a is located between the first winding portion 25a and the bottom surface 10b of the base body 10. The second winding portion 35a is opposed to the bottom surface 10a of the base body 10. The third lead-out portion 35b extends from one end of the second winding portion 35a to the top surface 10a of the base body 10 along the T axis. One end of the third lead-out portion 35b is exposed to the outside of the base body 10 through the top surface 10a of the base body 10. The third lead-out portion 35b is connected with the third external electrode 23 at the exposed surface exposed through the top surface 10a. The fourth lead-out portion 35c extends from the other end of the second winding portion 35a to the top surface 10a of the base body 10 along the T axis. One end of the fourth lead-out portion 35c is exposed to the outside of the base body 10 through the top surface 10a of the base body 10. The fourth lead-out portion 35c is connected with the fourth external electrode 24 at the exposed surface exposed through the top surface 10a.

The first conductor 25 and the second conductor 25 are formed of a metal material having a high conductivity. Examples of the metal material for the first coil conductor 25 and the second coil conductor 35 include Ag or Cu. For example, the first coil conductor 25 and the second coil conductor 35 can be made from metal strips or wires using a winding machine. The surface of the first coil conductor 25 and the surface of the second coil conductor 35 may be covered by an insulating film (not shown) made of insulating material having an excellent insulation property. The insulating film may be an oxide film formed on the surface of the first coil conductor 25 and the surface of the second coil conductor 35 during the heat treatment in the manufacturing process of the magnetic coupling coil component 1. The insulating film may be a coating film made of resin having an excellent insulation property, such as polyurethane, polyamide imide, polyimide, polyester, polyester imide.

The first coil conductor 25 is covered by the first base body portion 11 of the base body 10. In one embodiment, the first coil conductor 25 is covered by the first base body portion 11 such that the first coil surface 25a1 of the first winding portion 25a is exposed through the first surface 11a1 of the main body portion 11a. The second coil conductor 35 is covered by the second base body portion 12 of the base body 10. The first base body portion 11 is configured such that its dimension in the L-axis direction and its dimension in the W-axis direction are smaller than the dimension in the L-axis direction and the dimension in the W-axis direction of the second base body portion 12.

In the embodiment shown, the second base body portion 12 has a recess formed from the top surface of the base body 10 toward the interior of the base body 10, and the recess receives the first base body portion 11. Thus, the top surface 10a of the base body 10 is defined by the top surface of the first base body portion 11 and the top surface of the second base body portion 12.

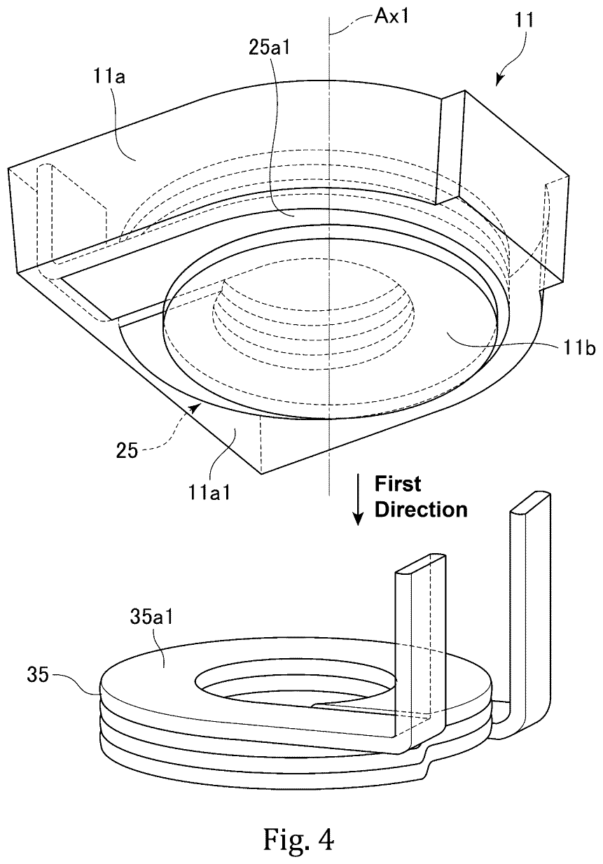

With reference to FIG. 4, a further description is given of the first base body portion 11. As shown in FIG. 4, the first base body portion 11 includes the main body portion 11a and the protruding portion 11b. The main body portion 11a covers the first coil conductor 25 such that the first coil surface 25a1 of the first winding portion 25a is exposed through the first surface 11a1. The protruding portion 11b protrudes from the first surface 11a1 of the main body portion 11a toward the first direction by the dimension D1. In the illustrated embodiment, the protruding portion 11b has a circular shape as viewed from the direction along the coil axis Ax1. The shape of the protruding portion 11b as viewed from the direction along the coil axis Ax1 is not limited to a circular shape, but can be elliptic, oval, and other shapes.

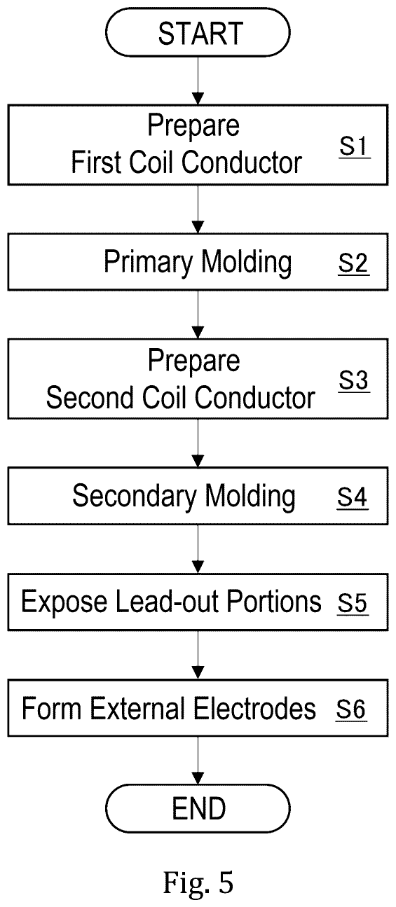

Next, a description is given of an example of a manufacturing method of the magnetic coupling coil component 1, in accordance with the flowchart shown in FIG. 5. In the first step S1, a first coil conductor 25 is prepared. As described above, the first coil conductor 25 includes a first winding portion 25a extending along the circumferential direction around the coil axis Ax1, a first lead-out portion 25b extending from one end of the first winding portion 25a in the direction parallel to the coil axis, and a second lead-out portion 25c extending from the other end of the first winding portion 25a in the direction parallel to the coil axis. The first coil conductor 25 can be made from a strip or wire formed of conductive material, using commercially available spindle-type coil winding machines, commercially available flyer-type coil winding machines, or other known coil winding machines. Since the method of making the first coil conductor 25 is obvious to those skilled in the art, a detailed description of the method is omitted.

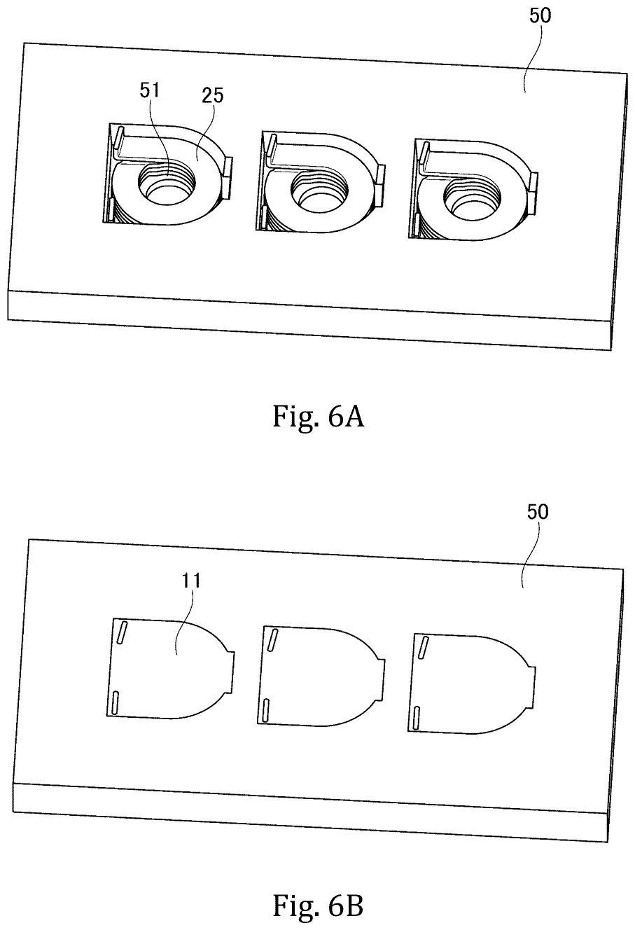

In step S2, primary molding is performed to form the first base body portion 11. The first base body portion 11 is formed by insert molding, for example. When the first base body portion 11 is formed by insert molding, the following steps are performed. First, a first molding die 50 with a cavity 51 is prepared, as shown in FIG. 6A, and the first coil conductor 25 prepared in step S1 is set in this cavity 51. Then, a mixed composition containing magnetic material and resin is filled into the cavity 51, as shown in FIG. 6B. The mixed composition filled into the cavity 51 is, for example, a resin composition containing magnetic powder of a soft magnetic metal and resin. The composition filled in the cavity 51 is pressurized with a punch, and the mixed composition in the cavity 51 is heated at a molding temperature higher than the hardening temperature of the resin contained in the mixed composition in the cavity 51, thereby forming the first base body portion 11 with the first coil conductor 25 embedded inside. The first base body portion 11 is removed from the first molding die 50 for later processing.

As described above, the first base body portion 11 thus formed includes a main body portion 11a, which covers the first coil conductor 25, and a protruding portion 11b, which protrudes toward the first direction from the main body portion 11a. The cavity 51 of the first molding die 50 used in step S2 is formed slightly larger than the first coil conductor 25, so that the first coil conductor 25 can be precisely placed in the first base body portion 11.

Next, in step S3, a second coil conductor 35 is prepared. As described above, the second coil conductor 35 includes a second winding portion 35a extending along the circumferential direction around the coil axis, a third lead-out portion 35b extending from one end of the second winding portion 35a in the direction parallel to the coil axis, and a fourth lead-out portion 35c extending from the other end of the second winding portion 35a in the direction parallel to the coil axis. The second coil conductor 35 can be made in the same way as the first coil conductor 25, using a known winding machine.

Next, in step S4, secondary molding is performed to form the second base body portion 12. In the secondary molding, a second molding die (not shown) is prepared that is different from the first molding die 50 used in the primary molding. The second molding die has a cavity formed therein. In step S4, the first base body portion 11 and the second coil conductor 35 are first placed in this cavity. For example, the first base body portion 11 may be placed in the cavity, and the second coil conductor 35 may be assembled to the first base body portion 11 in the cavity. Alternatively, the second coil conductor 35 may be assembled to the first base body portion 11 to make an assembly, and the assembly may be placed in the cavity of the second molding die. The second coil conductor 35 is assembled to the first base body portion 11 such that the second coil surface 35a1 directly contacts the protruding portion 11b of the first base body portion 11. The second coil conductor 35 is also assembled to the first base body portion 11 such that its coil axis is parallel to the coil axis of the first coil conductor 25 embedded in the first base body portion 11.

In step S4, a mixed composition containing magnetic material and resin is then filled into the cavity of the second molding die in which the assembly of the first base body portion 11 and the second coil conductor 35 is placed. The mixed composition filled into the cavity of the second molding die in the secondary molding may be either the same as or different from the mixed composition filled into the cavity 51 of the first molding die 50 in the primary molding. Next, the composition filled in the cavity of the second molding die is pressurized with a punch together with the assembly of the first base body portion 11 and the second coil conductor 35. Next, the composition in the cavity is heated at a molding temperature higher than the hardening temperature of the resin contained in the composition in the cavity, thereby forming a composite molded body in which the first base body portion 11 and the second base body portion 12 are combined together. When the magnetic material contains epoxy resin, the molding temperature may be about 150° C. Thus, in step S4, a composite molded body is obtained in which the first base body portion 11 and the second base body portion 12 are combined together.

Next, the composite molded body formed as described above is removed from the second molding die, and one surface of the composite molded body removed from the second molding die is ground by a cutting blade or laser to expose the end surfaces of the first lead-out portion 25b, second lead-out portion 25c, third lead-out portion 35b, and fourth lead-out portion 35c. After the grinding, the base body 10 including the first base body portion 11 and the second base body portion 12 is obtained.

Next, a conductive paste is applied so as to cover the exposed surfaces of the first lead-out portion 25b, second lead-out portion 25c, third lead-out portion 35b, and fourth lead-out portion 35c that are exposed through one surface (top surface 10a) of the base body 10, thereby forming the first external electrode 21, second external electrode 22, third external electrode 23, and fourth external electrode 24. The conductive paste contains conductive materials having excellent conductivity such as Ag, Pd, Cu, Al, Ni or alloys of these metals. The first external electrode 21 and the second external electrode 22 may each have a plating layer formed on the surfaces thereof. There may be two or more plating layers. The two plating layers may include a Ni plating layer and a Sn plating layer externally provided on the Ni plating layer.

In the above-described manner, the magnetic coupling coil component 1 is manufactured. According to the above manufacturing method, the first base body portion 11 is formed to have an outer shape according to the shape of the cavity 51, so that the first base body portion 11 can be produced with high dimensional accuracy. In addition, the first coil conductor 25 is exposed through the first surface 11a1 of the first base body portion 11, and the second coil conductor 35 is assembled to the first base body portion 11 so that the second coil surface 35a1 is in direct contact with the protruding portion 11b. Thus, the distance between the first coil conductor 25 and the second coil conductor 35 can be equal to the dimension D1 of the protruding portion 11b in the axial direction along the coil axis Ax1. Therefore, in the magnetic coupling coil component 1 manufactured as described above, the distance between the first coil conductor 25 and the second coil conductor 35 has high dimensional accuracy.

According to the above manufacturing method, the first base body portion 11 is produced using the first molding die 50 having the cavity 51 that is slightly larger than the first coil conductor 25, and thus the misplacement of the first coil conductor 25 from its predetermined installation position within the first base body portion 11 can be minimized.

As described above, the above manufacturing method can produce a magnetic coupling coil component 1 having high dimensional accuracy for the distance between the first coil conductor 25 and the second coil conductor 35 in the base body 10.

One or more of the steps of the manufacturing method described herein can be omitted as appropriate. In the method of manufacturing the magnetic coupling coil component 1, one or more steps not explicitly described herein may be performed as necessary. Some of the steps included in the above-described method of manufacturing the magnetic coupling coil component 1 may be carried out in a different order as needed, without departing from the spirit of the present invention. Some of the steps included in the above-described method of manufacturing the magnetic coupling coil component 1 may be performed simultaneously or in parallel, if possible.

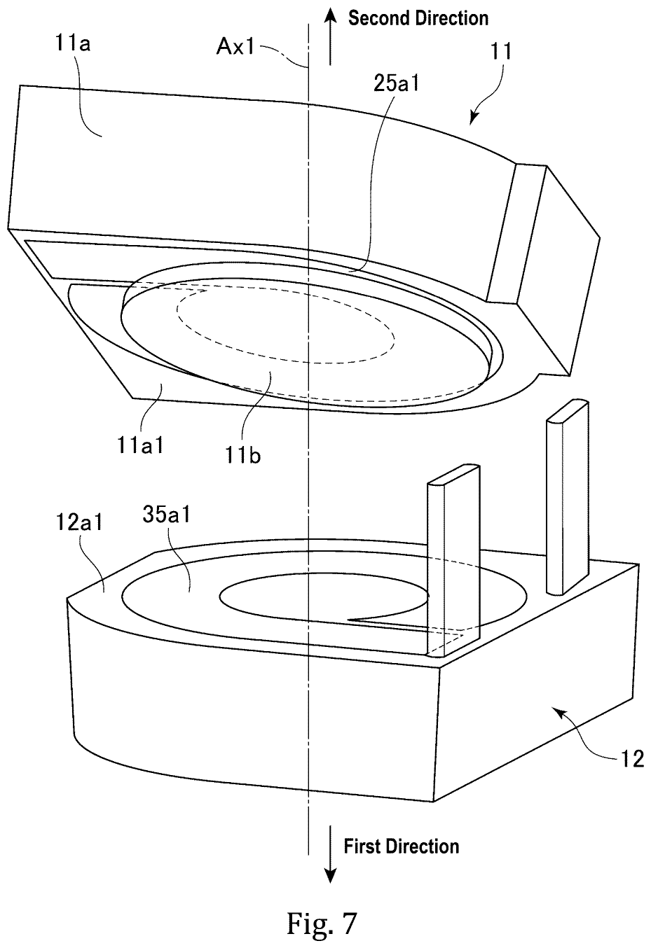

The processing in each of the above steps can be modified as needed. For example, in step S4, instead of assembling the bare second coil conductor 35 directly to the first base body portion 11, the second coil conductor 35 may be embedded in the second base body portion 12 and then the second base body portion 12 having the second coil conductor 35 embedded therein may be assembled to the first base body portion 11, as shown in FIG. 7. In this case, the second base body portion 12 having the second coil conductor 35 embedded therein can be produced by insert molding. The second base body portion 12 covers the second coil conductor 35 so that the second coil surface 35a1 of the second winding portion 35a is exposed through the second surface 12a1, which is the end surface of the second base body portion 12 in the second direction. This allows the second base body portion 12 to be assembled to the first base body portion 11 so that the second coil surface 35a1 of the second winding portion 35a exposed through the second surface 12a1 contacts the protruding portion 11b of the first base body portion 11.

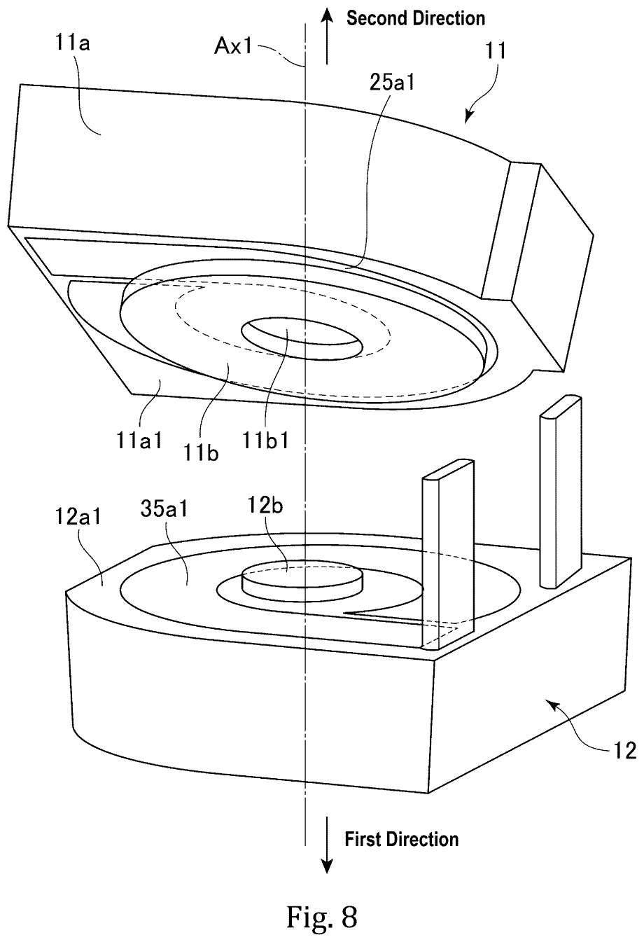

As shown in FIG. 8, the protruding portion 11b of the first base body portion 11 may have a hollow 11b1 formed toward the inside of the first base body portion 11, and the second base body portion 12 may have a protrusion 12b protruding from the second surface 12a1 toward the second direction. For example, the hollow 11b1 may have a complementary shape to the protrusion 12b and may be configured to receive the protrusion 12b when the second base body portion 12 is assembled to the first base body portion 11. Appropriate positioning of the hollow 11b1 and the protrusion 12b allows accurate positioning of the second base body portion 12 with respect to the first base body portion 11 when the second base body portion 12 is assembled to the first base body portion 11.

The arrangement of the protrusion 12b and the hollow 11b1 receiving the protrusion 12b shown in FIG. 8 may be modified as needed. For example, the protrusion 12b may be provided on the first base body portion 11, and the hollow 11b1 that receives the protrusion 12b may be provided in the second base body portion 12. In this case, the protrusion 12b may be formed on the end surface of the protruding portion 11b of the first base body portion 11 in the first direction so as to protrude in the first direction from the end surface, and the hollow 11b1 may be formed in the second surface 12a1 of the second base body portion 12 so as to receive the protrusion 12b formed on the protruding portion 11b.

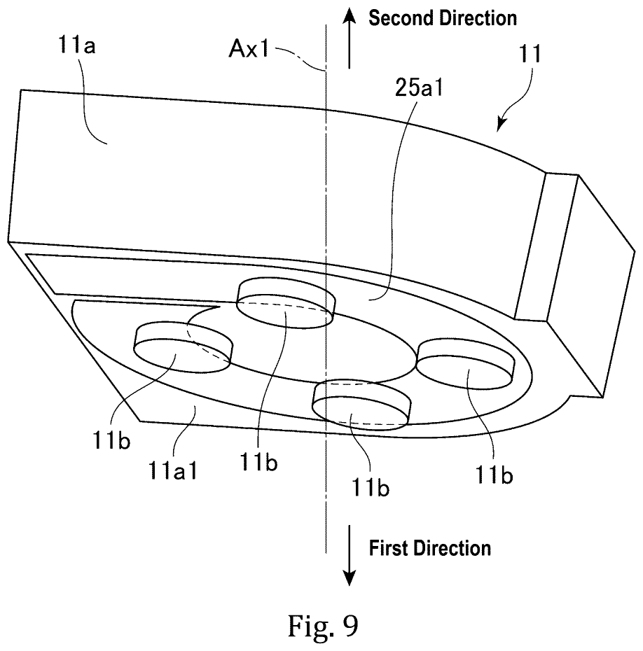

Next, with reference to FIG. 9, a description is given of a modification of the first base body portion 11. FIG. 9 is a schematic view showing a modification of the first base body portion 11. In the first base body portion 11 shown in FIG. 9, a plurality of protruding portions 11b are provided on the first surface 11a1 of the main body portion 11a. In one embodiment of the invention, the plurality of protruding portions 11b have the same dimension in the axial direction along the coil axis Ax1. The second coil conductor 35 is assembled to the first base body portion 11 so that the second coil surface 35a1 of the second coil conductor 35 contacts each of the plurality of protruding portions 11b.

In FIG. 9, each of the plurality of protruding portions 11b has a circular shape as viewed from the axial direction along the coil axis Ax1. Some of the plurality of protruding portions 11b may have either the same shape as the other protruding portions 11b or different shapes than the others. The plurality of protruding portions 11b may have different dimensions in the radial direction. Although FIG. 9 shows four protruding portions 11b formed on the first base body portion 11, the number of protruding portions 11b formed on the first base body portion 11 is not limited to four. The number of protruding portions 11b formed on the first base body portion 11 may be three or less, or it may be five or more.

The dimensions, materials, and arrangements of the constituent elements described for the above various embodiments are not limited to those explicitly described for the embodiments, and these constituent elements can be modified to have any dimensions, materials, and arrangements within the scope of the present invention.

Constituent elements not explicitly described herein can also be added to the above-described embodiments, and it is also possible to omit some of the constituent elements described for the embodiments.

The words “first,” “second,” “third” and so on used herein are added to distinguish constituent elements but do not necessarily limit the numbers, orders, or contents of the constituent elements. The numbers added to distinguish the constituent elements should be construed in each context. The same numbers do not necessarily denote the same constituent elements among the contexts. The use of numbers to identify constituent elements does not prevent the constituent elements from performing the functions of the constituent elements identified by other numbers.

This specification also discloses the following embodiments.

### Additional Embodiment 1

A magnetic coupling coil component (1), comprising:
a first coil conductor (25) including a first winding portion (25a) extending in a circumferential direction around a coil axis (Ax1);
a first base body portion (11) including a main body portion (11a) and at least one protruding portion (11b), the main body portion covering the first coil conductor and having a first surface (11a1), the first surface being an end surface in a first direction along the coil axis, the at least one protruding portion protruding from the first surface of the main body portion;
a second coil conductor (35) including a second winding portion (35a) extending in a circumferential direction around the coil axis, the second coil conductor being positioned such that the second winding portion is in contact with the at least one protruding portion;
a second base body portion (12) covering the second coil conductor;
a first external electrode (21) connected to one end of the first coil conductor;
a second external electrode (22) connected to another end of the first coil conductor;
a third external electrode (23) connected to one end of the second coil conductor; and
a fourth external electrode (24) connected to another end of the second coil conductor.

### Additional Embodiment 2

The magnetic coupling coil component of Additional Embodiment 1, wherein a distance between the first coil conductor and the second coil conductor in the first direction is equal to a dimension (D1) of the at least one protruding portion in one axial direction along the coil axis.

### Additional Embodiment 3

The magnetic coupling coil component of Additional Embodiment 1 or 2, wherein in a radial direction centered on the coil axis, an outer diameter of the at least one protruding portion is larger than an inner diameter (D4) of the second winding portion.

### Additional Embodiment 4

The magnetic coupling coil component of any one of Additional Embodiments 1 to 3, wherein in a radial direction centered on the coil axis, an outer diameter of the at least one protruding portion is smaller than an outer diameter (D5) of the second winding portion.

### Additional Embodiment 5

The magnetic coupling coil component of any one of Additional Embodiments 1 to 4, wherein the main body portion covers the first coil conductor such that a first coil surface (25a1) of the first winding portion is exposed through the first surface, the first coil surface being an end surface of the first winding portion in the first direction.

### Additional Embodiment 6

The magnetic coupling coil component of any one of Additional Embodiments 1 to 5, wherein the second coil conductor is positioned such that a second coil surface (35a1) of the second winding portion is in contact with the at least one protruding portion, the second coil surface being an end surface of the second winding portion in a second direction opposite to the first direction.

### Additional Embodiment 7

The magnetic coupling coil component of any one of Additional Embodiments 1 to 6, wherein the main body portion and the at least one protruding portion have one-piece structure.

### Additional Embodiment 8

The magnetic coupling coil component of any one of Additional Embodiments 1 to 7, wherein the at least one protruding portion comprises a plurality of protruding portions, and wherein the second coil conductor is positioned so as to be in contact with each of the plurality of protruding portions.

### Additional Embodiment 9

The magnetic coupling coil component of Additional Embodiment 8, wherein the plurality of protruding portions have a same dimension in a direction along the coil axis.

### Additional Embodiment 10

The magnetic coupling coil component of any one of Additional Embodiments 1 to 9, wherein the second base body portion has a second surface (12a1) and at least one protrusion (12b), the second surface being an end surface in a second direction opposite to the first direction, the at least one protrusion protruding from the second surface, and wherein the at least one protruding portion of the first base body portion has a hollow (11b1) receiving the at least one protrusion.

### Additional Embodiment 11

The magnetic coupling coil component of any one of Additional Embodiments 1 to 10, wherein the at least one protruding portion has at least one protrusion protruding toward the first direction from an end surface in the first direction, and wherein the second base body portion has a hollow receiving the at least one protrusion.

### Additional Embodiment 12

A method of manufacturing a magnetic coupling coil component, comprising the steps of:
(S1) preparing a first coil conductor including a first winding portion extending in a circumferential direction around a first coil axis;
(S2) filling first magnetic material into a first molding die (50) having the first coil conductor placed therein, so as to form a first base body portion including a main body portion and at least one protruding portion, the main body portion covering the first coil conductor and having a first surface, the first surface being an end surface in a first direction along the first coil axis, the at least one protruding portion protruding from the first surface;
(S3) preparing a second coil conductor including a second winding portion extending in a circumferential direction around a second coil axis;
assembling the second coil conductor to the first base body portion such that the second winding portion is in contact with the at least one protruding portion of the first base body portion;
providing a first external electrode so as to be connected to one end of the first coil conductor;
providing a second external electrode so as to be connected to another end of the first coil conductor;
providing a third external electrode so as to be connected to one end of the second coil conductor; and
providing a fourth external electrode so as to be connected to another end of the second coil conductor.

What is claimed is:

1. A magnetic coupling coil component, comprising:
a first coil conductor including a first winding portion extending in a circumferential direction around a coil axis;
a first base body portion including a main body portion and at least one protruding portion, the main body portion covering the first coil conductor and having a first surface, the first surface being an end surface in a first direction along the coil axis, the at least one protruding portion protruding from the first surface of the main body portion;
a second coil conductor including a second winding portion extending in a circumferential direction around the coil axis, the second coil conductor being positioned such that the second winding portion is in contact with the at least one protruding portion;
a second base body portion covering the second coil conductor;
a first external electrode connected to one end of the first coil conductor;
a second external electrode connected to another end of the first coil conductor;
a third external electrode connected to one end of the second coil conductor; and
a fourth external electrode connected to another end of the second coil conductor.

2. The magnetic coupling coil component of claim 1, wherein a distance between the first coil conductor and the second coil conductor in the first direction is equal to a dimension of the at least one protruding portion in one axial direction along the coil axis.

3. The magnetic coupling coil component of claim 1, wherein in a radial direction centered on the coil axis, an outer diameter of the at least one protruding portion is larger than an inner diameter of the second winding portion.

4. The magnetic coupling coil component of claim 1, wherein in a radial direction centered on the coil axis, an outer diameter of the at least one protruding portion is smaller than an outer diameter of the second winding portion.

5. The magnetic coupling coil component of claim 1, wherein the main body portion covers the first coil conductor such that a first coil surface of the first winding portion is exposed through the first surface, the first coil surface being an end surface of the first winding portion in the first direction.

6. The magnetic coupling coil component of claim 1, wherein the second coil conductor is positioned such that a second coil surface of the second winding portion is in contact with the at least one protruding portion, the second coil surface being an end surface of the second winding portion in a second direction opposite to the first direction.

7. The magnetic coupling coil component of claim 1, wherein the main body portion and the at least one protruding portion have one-piece structure.

8. The magnetic coupling coil component of claim 1,
wherein the at least one protruding portion comprises a plurality of protruding portions, and
wherein the second coil conductor is positioned so as to be in contact with each of the plurality of protruding portions.

9. The magnetic coupling coil component of claim 8, wherein the plurality of protruding portions have a same dimension in a direction along the coil axis.

10. The magnetic coupling coil component of claim 1,
wherein the second base body portion has a second surface and at least one protrusion, the second surface being an end surface in a second direction opposite to the first direction, the at least one protrusion protruding from the second surface, and
wherein the at least one protruding portion of the first base body portion has a hollow receiving the at least one protrusion.

11. The magnetic coupling coil component of claim 1,
wherein the at least one protruding portion has at least one protrusion protruding toward the first direction from an end surface in the first direction, and
wherein the second base body portion has a hollow receiving the at least one protrusion.

12. A method of manufacturing a magnetic coupling coil component, comprising the steps of:
preparing a first coil conductor including a first winding portion extending in a circumferential direction around a first coil axis;
filling first magnetic material into a first molding die having the first coil conductor placed therein, so as to form a first base body portion including a main body portion and at least one protruding portion, the main body portion covering the first coil conductor and having a first surface, the first surface being an end surface in a first direction along the first coil axis, the at least one protruding portion protruding from the first surface;
preparing a second coil conductor including a second winding portion extending in a circumferential direction around a second coil axis;
assembling the second coil conductor to the first base body portion such that the second winding portion is in contact with the at least one protruding portion of the first base body portion;
providing a first external electrode so as to be connected to one end of the first coil conductor;
providing a second external electrode so as to be connected to another end of the first coil conductor;
providing a third external electrode so as to be connected to one end of the second coil conductor; and
providing a fourth external electrode so as to be connected to another end of the second coil conductor.
